(19) United States
(12) Patent Application Publication
(10) Pub. No.: US 2015/0090531 A1
(43) Pub. Date: Apr. 2, 2015

(54) ASSEMBLED A-SHAPED LADDER

(71) Applicant: PI-CHEN YANG, New Taipei City (TW)

(72) Inventor: PI-CHEN YANG, New Taipei City (TW)

(21) Appl. No.: 14/038,781

(22) Filed: Sep. 27, 2013

(51) Int. Cl. E06C 1/18; E06C 1/38; E06C 1/16

(52) U.S. Cl. CPC E06C 1/18; E06C 1/16; E06C 1/38
USPC 182/104

(57) ABSTRACT

An assembled ladder is formed by coupling a top ladder segment, a plurality of middle ladder segments, and a plurality of bottom ladder segments together. The bottom ladder segments include a ladder body, support frame assemblies, ancillary frames, adjustable support pads, and adjustable coupling members. The support frame assemblies are respectively set at two sides of the ladder body. The ancillary frames are mounted to the support frame assembly. The adjustable support pads are screwed to the ancillary frames. The adjustable coupling members have an end coupled to the support frame assemblies and are partially received in the receiving space. With the adjustable coupling members fixing the support frame assemblies, the ancillary frames are expanded. Through adjustment made with the adjustable support pads, the ladder can be set more stably to achieve safety and convenience of use.

### TECHNICAL FIELD OF THE INVENTION

The present invention generally relates to an assembled A-shaped ladder, and more particularly to an assembled A-shaped ladder of which the use is safe and convenient.

### DESCRIPTION OF THE PRIOR ART

In a modern society, the space available is generally limited. Thus, development is generally made in a vertical direction to expand the amount of space that is available to the people.

A multi-story building or a skyscraper is a typical example, in which a lot of living-support facility (such as fire detectors, lighting devices, and surveillance devices) is mounted at locations where people cannot reach with their hands. In addition, a street lamp, elevator facility, or a water tower is generally reachable only with the aid of proper assistive tools.

One of the simplest forms of the assistive tools is a ladder. Climbing up the ladder, a user may reach a site where it is not reachable normally and a desired operation can then be carried out at such a site.

For all types of ladder, the general structure is a ladder body having two support points. However, when the ladder gets higher, it often occurs that the support provided by the two support points is generally insufficient to keep the ladder in an erected, standing condition. Once the ladder falls down, the person climbing on the ladder may get seriously injured. In addition, the conventional ladders often have a fixed height for each specific ladder. In case of an attempt to increase the height of the ladder, usually, a new ladder must be purchased to meet the desire for the increased ladder height.

### SUMMARY OF THE INVENTION

The primary object of the present invention is to increase the contact points between a ladder body and the ground and to enhance the stability by using support frame assemblies, ancillary frames, and adjustable support pads and to allow these components to be stowed for easy movement and transportation.

The secondary object of the present invention is to allow for change of height for adjustment and selection by using a top ladder segment, middle ladder segments, and bottom ladder segments.

The present invention provides an assembled A-shaped ladder, which is an assembled ladder that is formed by coupling together a top ladder segment, a plurality of middle ladder segments, and a plurality of bottom ladder segments, wherein the bottom ladder segments comprise a ladder body, a plurality of support frame assemblies, a plurality of ancillary frames, a plurality of adjustable support pads, and a plurality of adjustable coupling members for adjusting and fixing the support frame assemblies and the ladder body. The support frame assemblies have an end coupled to the ladder body. The support frame assemblies are respectively set at two sides of the ladder body. The ancillary frames are movably mounted to an end of the support frame assemblies that is distant from the ladder body. The adjustable support pads are screwed to an end of the ancillary frames that is distant from the support frame assemblies. The adjustable coupling members have an end coupled to the support frame assemblies and an opposite end received in the receiving space.

To use, the support frame assemblies are expanded leftward and rightward respectively and are fixed and supported by the adjustable coupling members. The ancillary frames received in the support frame assemblies are then rotated out to an operation condition. And, fine adjustment is carried out with the adjustable support pads to complete preparation for use. Afterwards, the top ladder segment and the middle ladder segments are inserted and coupled to each other and then coupled to the bottom ladder segments to allow a user to climb and use. The number of the middle ladder segments can be increased and/or decreased according to the desired height. As such, the contact area and support point are increased to thereby greatly improve the stability of use.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing an embodiment of the present invention in an assembled form.

FIG. 2 is another perspective view showing the embodiment of the present invention in the assembled form.

FIG. 3 is a perspective view showing a top ladder segment of the preferred embodiment of the present invention.

FIG. 4 is an exploded view of the top ladder segment of the preferred embodiment of the present invention.

FIG. 5 is a perspective view showing a middle ladder segment of the preferred embodiment of the present invention.

FIG. 6 is an exploded view of the middle ladder segment of the preferred embodiment of the present invention.

FIG. 7 is a perspective view showing a bottom ladder segment of the preferred embodiment of the present invention.

FIG. 8 is an exploded view of the bottom ladder segment of the preferred embodiment of the present invention.

FIG. 9 is a perspective view illustrating an operation of use of the bottom ladder segment of the preferred embodiment of the present invention.

FIG. 10 is another perspective view illustrating the operation of use of the bottom ladder segment of the preferred embodiment of the present invention.

FIG. 11 is a further perspective view illustrating an operation of use of the bottom ladder segment of the preferred embodiment of the present invention

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims

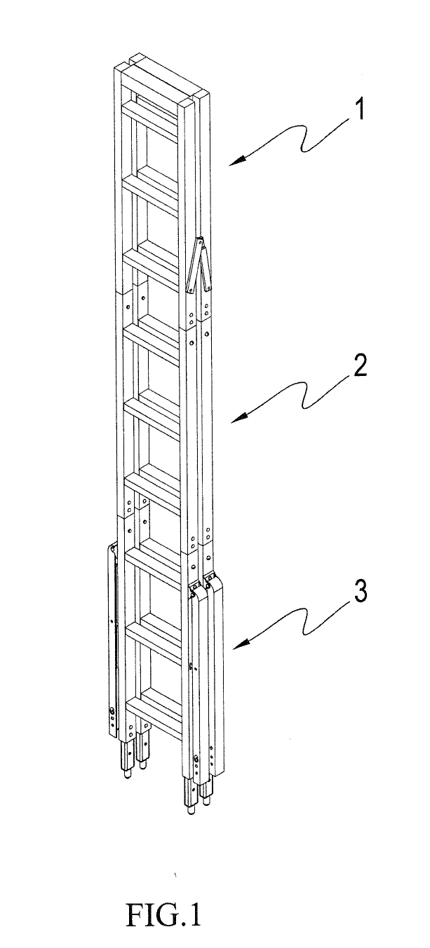

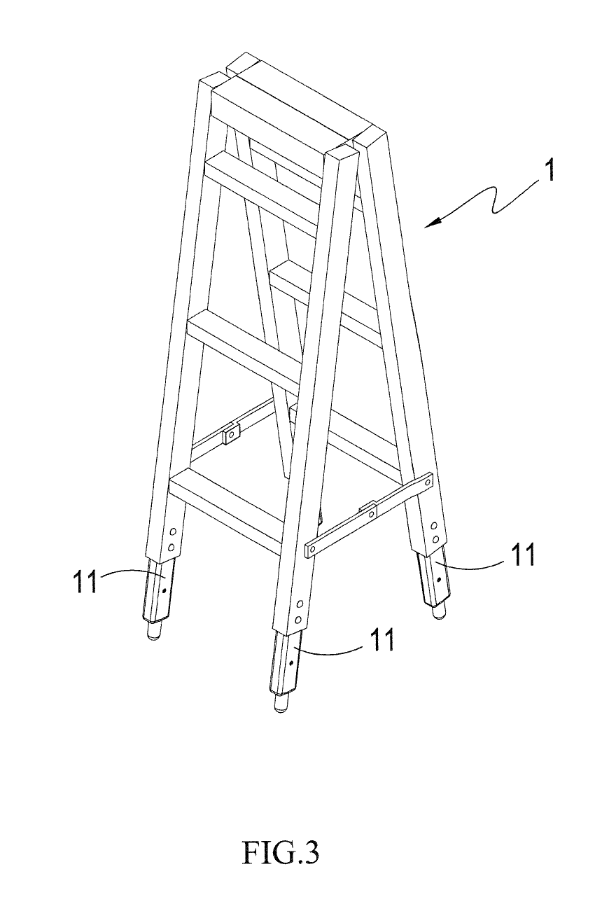

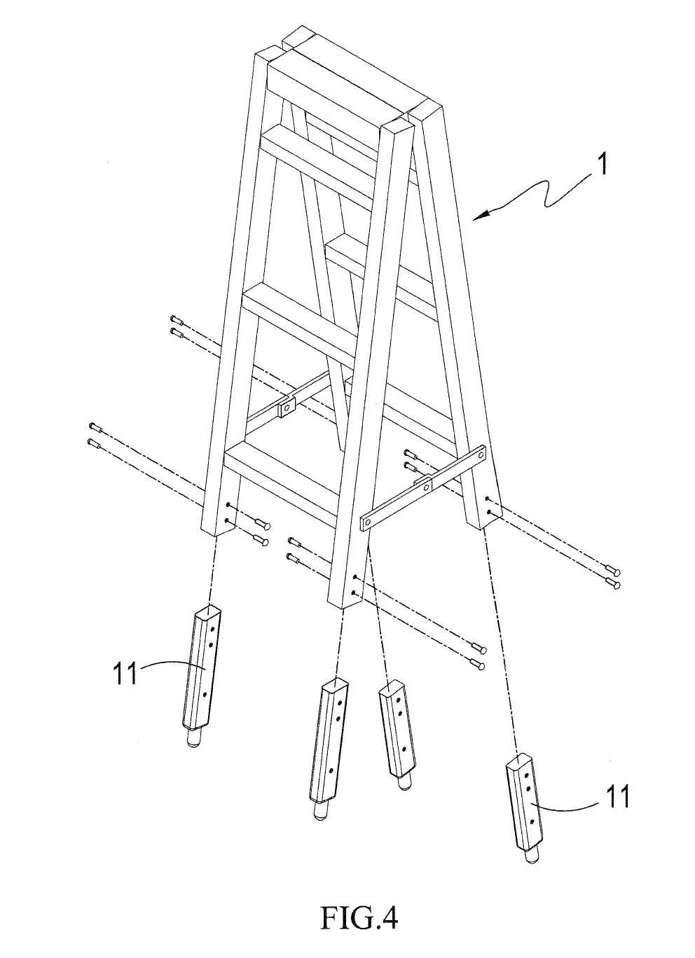

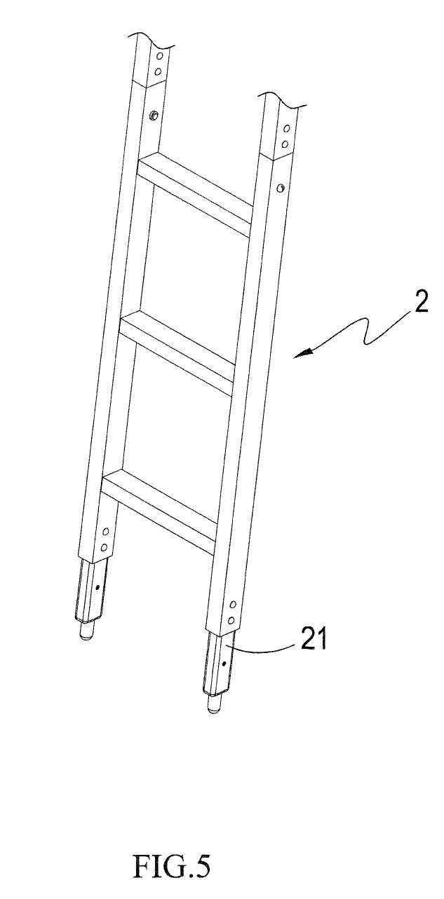

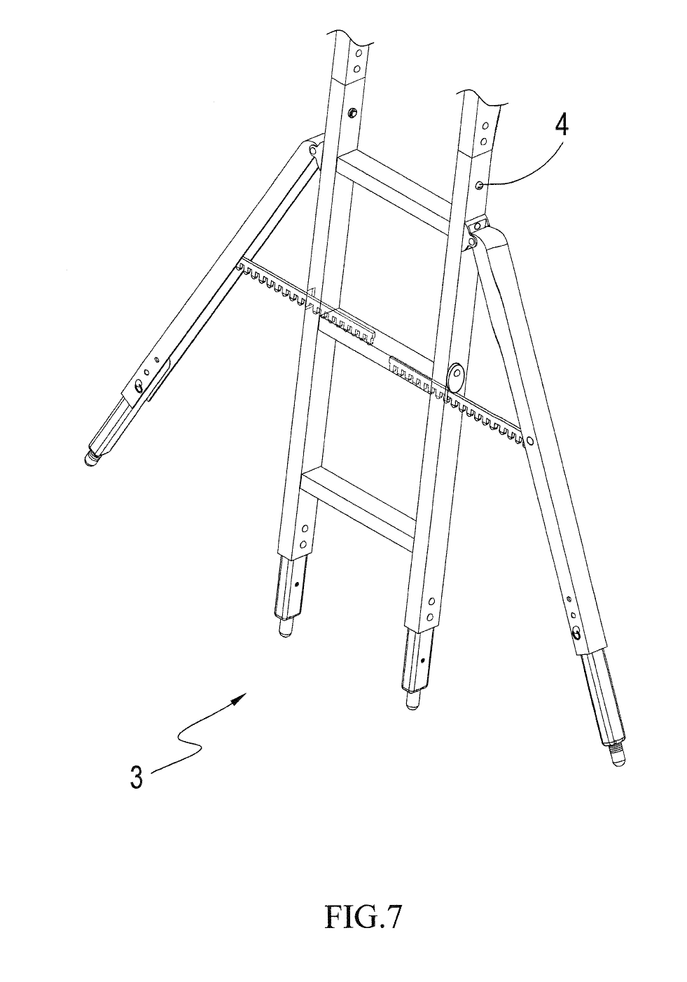

Referring to FIGS. 1-8, which are perspective views and exploded views of a ladder and components thereof according to a preferred embodiment of the present invention, these drawings clearly show that the present invention comprises the following components:

A top ladder segment 1 has a lower portion, which forms a plurality of top ladder segment support legs 11 for coupling purposes.

A plurality of middle ladder segments 2 is provided so that the middle ladder segments 2 have an upper portion forming an opening for receiving the top ladder segment support legs 11 to insert therein and couple thereto for being fixed together by means of mounting bolts 4 and a lower portion that forms a plurality of middle ladder segment support legs 21 for coupling purposes.

A plurality of bottom ladder segments 3 is provided so that the bottom ladder segments 3 have an upper portion forming an opening for receiving the middle ladder segment support legs 21 to insert therein and couple thereto for being fixed together by means of mounting bolts 4. The bottom ladder segments 3 further comprise the following components:

A ladder body 31 comprises a receiving space 311 formed therein.

A plurality of support frame assemblies 32 has an end coupled to the ladder body 31. The support frame assemblies 32 are respectively set at two sides of the ladder body 31.

A plurality of ancillary frames 33 is movably mounted to the end of the support frame assemblies 32 that is distant from the ladder body 31.

A plurality of adjustable support pads 34 is screwed to the end of the ancillary frames 33 that is distant from the support frame assemblies 32.

A plurality of adjustable coupling members 35 is provided for adjusting and fixing the support frame assemblies 32 and the ladder body 31. The adjustable coupling members 35 have an end coupled to the support frame assemblies 32 and an opposite end received in the receiving space 311.

In this arrangement, the ladder body 31 further comprises a plurality of fixing members 36, which is provided for fixing the adjustable coupling members 35. The fixing members 36 have an end mounted to the ladder body 31 and adopt eccentric rotation to conduct adjustment and fixing.

In this arrangement, the support frame assemblies 32 comprise a first hole 321 and a second hole 322 formed therein at a location adjacent to the ancillary frames 33. The ancillary frames 33 comprise a corresponding aperture 331 formed therein. The corresponding aperture 331 is selectively set to correspond to the first hole 321 or the second hole 322 to set the ancillary frames 33 in a stowed condition or an expanded condition to be fixed there by inserting a locking pin 5.

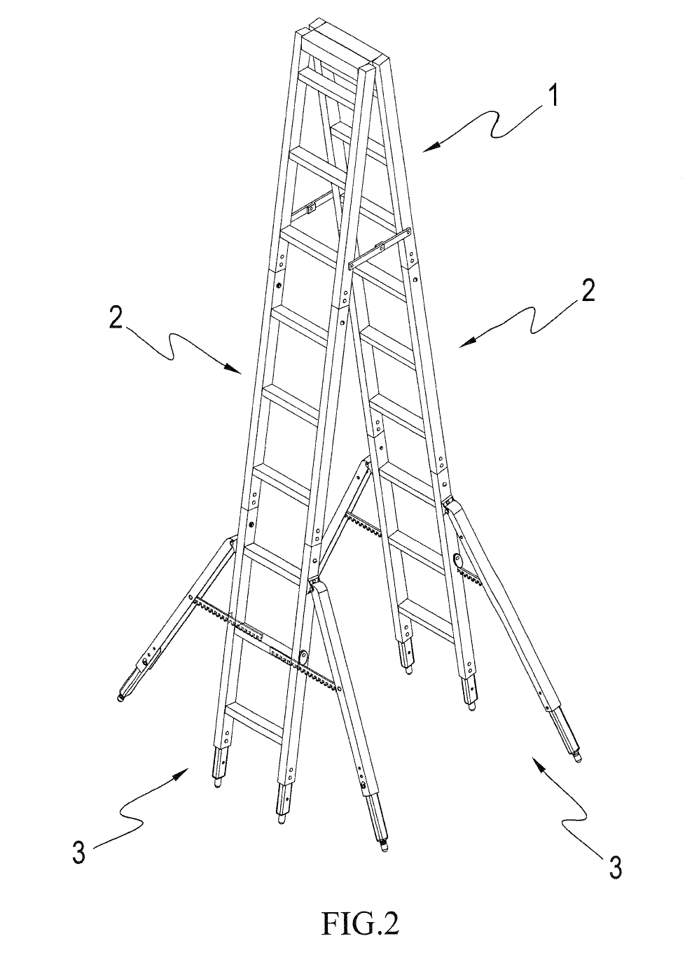

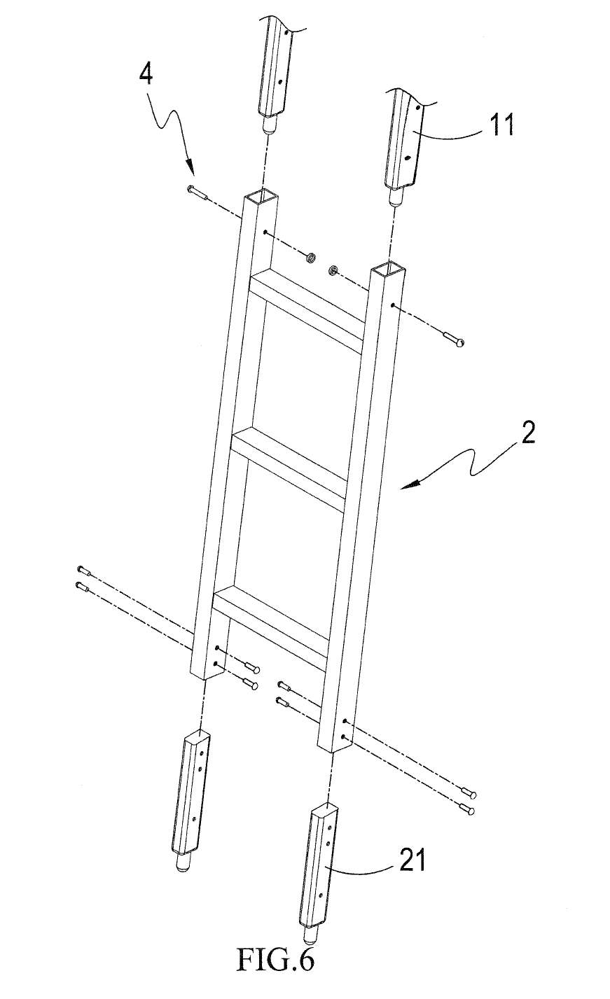

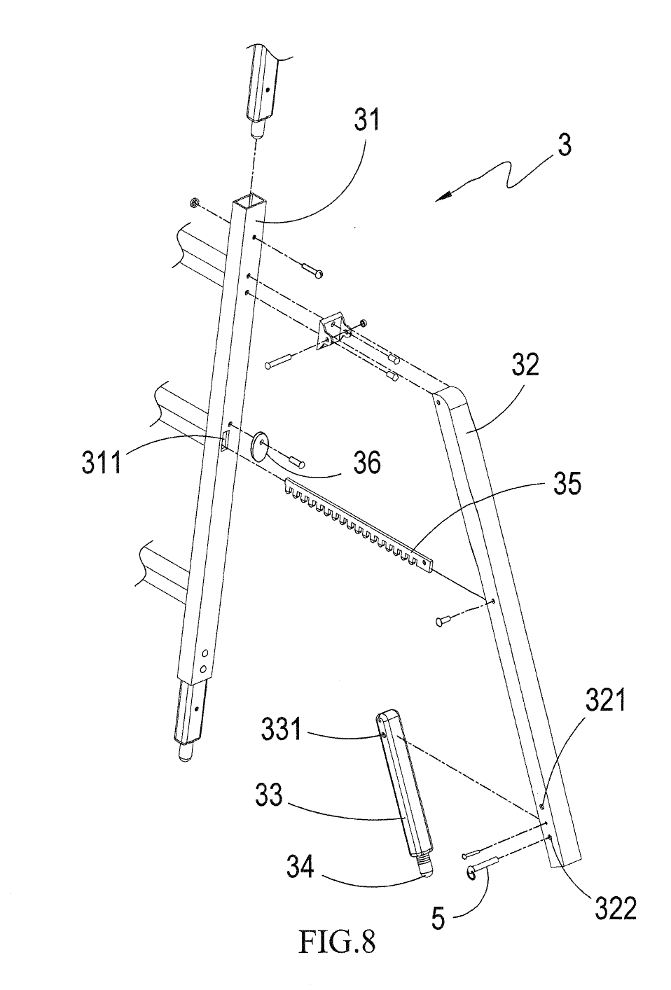

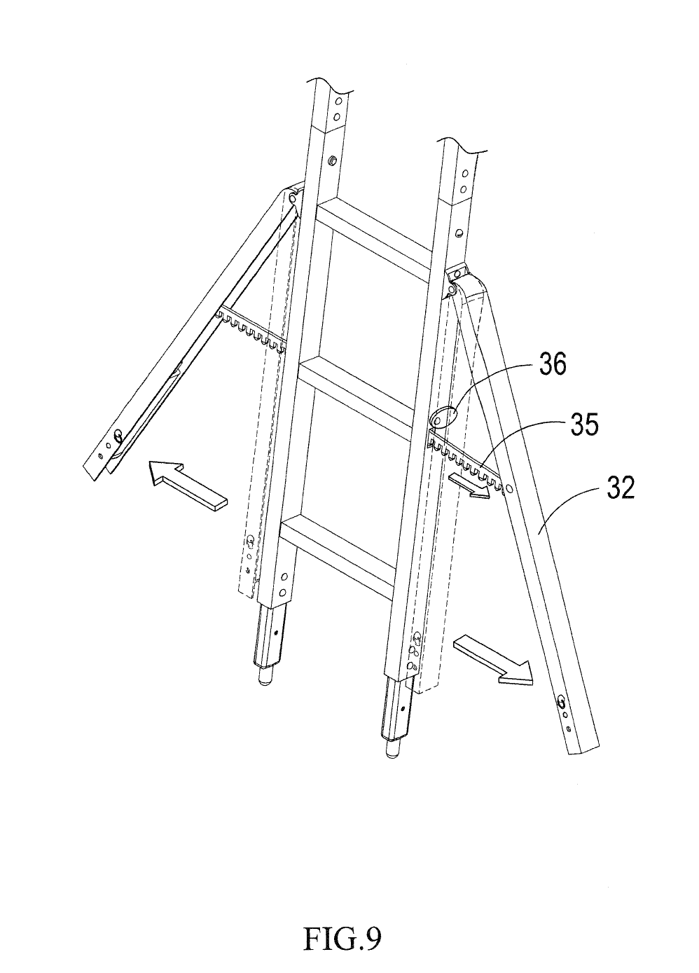

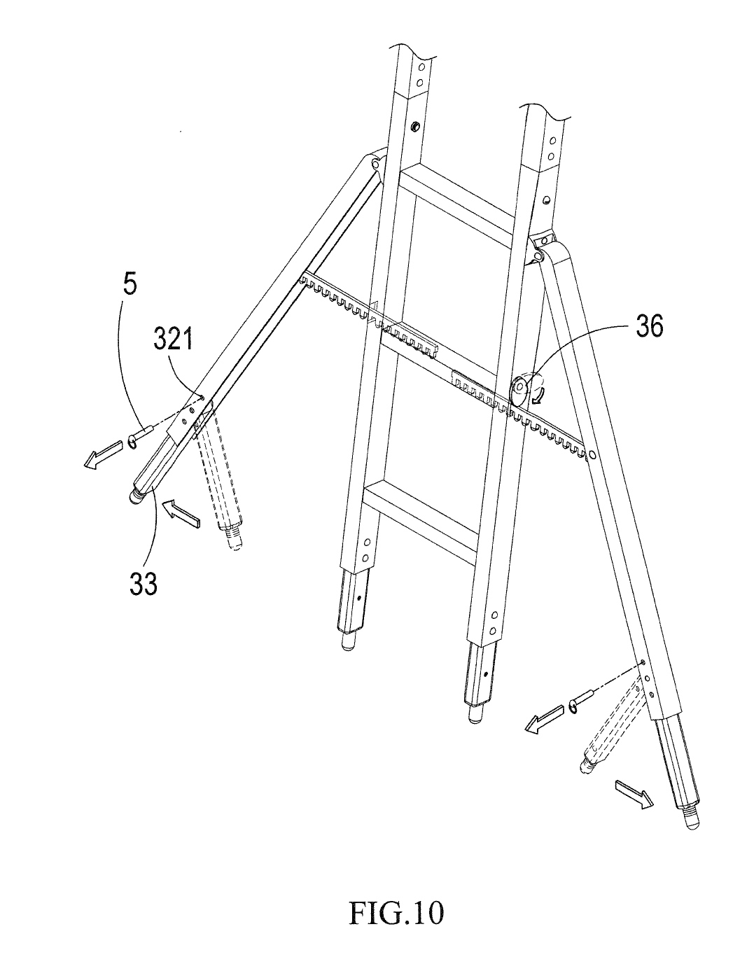

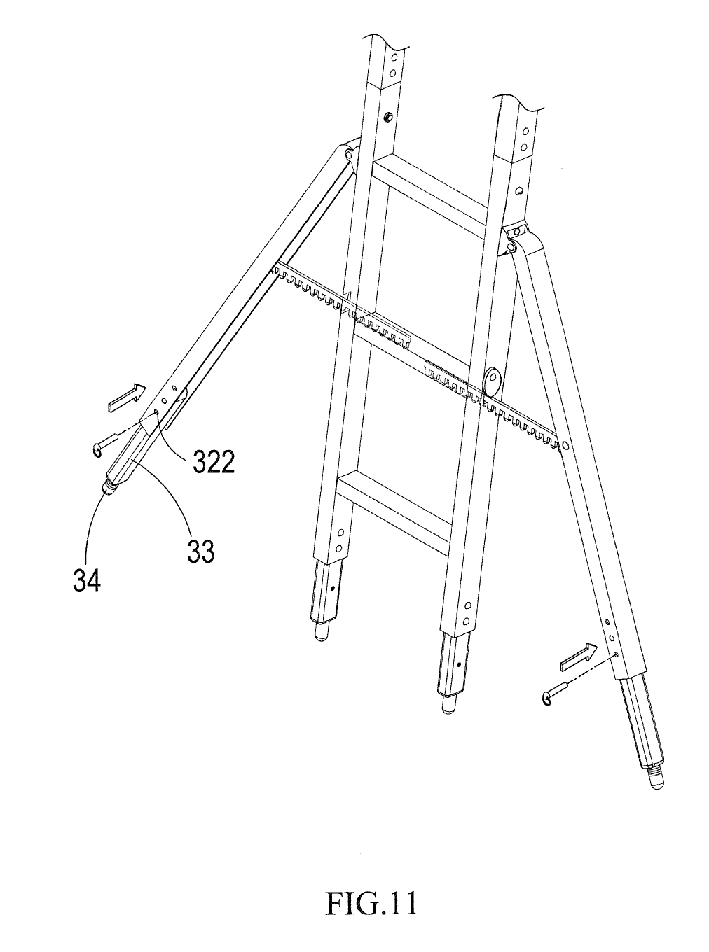

Referring to FIGS. 1-11, which are perspective views and exploded views of the ladder and components and operation of use thereof according to the preferred embodiment of the present invention, the drawings clearly show that in use, the top ladder segment 1, the middle ladder segments 2, and the bottom ladder segments 3 are coupled through insertion of the top ladder segment support legs 11 and the middle ladder segment support legs 21 and the mounting bolts 4 are applied to fix them (see FIGS. 6 and 8) and it can be used upon completion of the coupling (see FIG. 1). Through the collaboration among the support frame assemblies 32, the ancillary frames 33, the adjustable support pads 34, and the adjustable coupling members 35, the stability can be enhanced for the use thereof. A detailed description will be given to the operation, in combination with the structure, of the ladder. As shown in FIG. 9, normally, the fixing members 36 are used to secure and fix the adjustable coupling members 35. To use, the fixing members 36 are rotated to provide a space for the adjustable coupling members 35 to be lifted upwards. With the adjustable coupling members 35 being lifted and moved upwards, the support frame assemblies 32 that are located at left and right sides of the ladder body 31 are allowed extend leftward and rightward respectively to reach a predetermined opening angle. Afterwards, the adjustable coupling members 35 can be lowered down and fixed. (Here, the structure of the adjustable coupling members 35 is described, where the adjustable coupling members 35 comprises teeth that are of a curved design so that they will automatically slide when they are lowered down to allow the teeth to couple and fix to the ladder body 31.) After the adjustment of the opening angle of the adjustable coupling members 35 and the support frame assemblies 32 is completed, the fixing members 36 are used to engage and fix the adjustable coupling members (see FIG. 10). The locking pins 5 are withdrawn. (Normally, for easy movement and storage, the first hole 321 is set to correspond to the aperture 331 with the locking pin 5 received therethrough for fixing purposes.) The ancillary frames 33 are rotated, at the inner side of the support frame assemblies 32, to an operation position (namely, the second hole 322 being set to form a registered and communicating condition with he aperture 331). With the locking pins 5 being inserted through both the second holes 322 and the corresponding apertures 331, fixing can be achieved (see FIG. 11). Finally, according to the field site surface or the angles of the support frame assemblies 32, the adjustable support pads 34 are rotated to achieve fine adjustment of height thereby completely prepared for use (see FIG. 2). Under this condition, since thereby eight support points, position stability in the leftward and rightward directions can be greatly improved. Further, the present invention allows for increase and/or decrease of the number of the middle ladder segments 2 used according to a desired height to be reached so that an advantage of height adjustment is provided. After the use, the mounting bolts 4 are removed to allow the top ladder segment 1, the middle ladder segments 2, and the bottom ladder segments 3 to be detached from each other, wherein for the bottom ladder segments 3, a further operation of removing the locking pins 5 is necessary to allow the ancillary frames 33 to be rotated and received in the support frame assemblies 32. The fixing members 36 are also rotated and released to allow the adjustable coupling members 35 to be lifted for being received into the receiving space 311 of the ladder body 31. The support frame assemblies 32 and the ladder body 31 are moved toward each other to be positioned against each other. The fixing members 36 are then rotated back to secure the adjustable coupling members 35, thereby completing the stowed condition.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An assembled A-shaped ladder, which is an assembled ladder that is formed by coupling together a top ladder segment, a plurality of middle ladder segments, and a plurality of bottom ladder segments, wherein the bottom ladder segments comprise:
a ladder body, which comprises a receiving space formed therein;
a plurality of support frame assemblies, which has an end coupled to the ladder body, the support frame assemblies being respectively set at two sides of the ladder body;
a plurality of ancillary frames, which is movably mounted to an end of the support frame assemblies that is distant from the ladder body;
a plurality of adjustable support pads, which is screwed to an end of the ancillary frames that is distant from the support frame assemblies; and
a plurality of adjustable coupling members, which functions for adjusting and fixing the support frame assemblies and the ladder body, the adjustable coupling members having an end coupled to the support frame assemblies and an opposite end received in the receiving space.

2. The assembled A-shaped ladder according to claim 1, wherein the top ladder segment and the middle ladder segments each have a lower end that forms a plurality of support legs, the support legs being provided for insertion and fixing for coupling the top ladder segment, the middle ladder segments, and the bottom ladder segments together, the support legs comprising a fixing hole formed therein to receive a mounting bolt to insert therein for coupling purposes.

3. The assembled A-shaped ladder according to claim 1, wherein the ladder body further comprises a plurality of fixing members, which function to fix the adjustable coupling members, the fixing members having an end mounted to the ladder body and adopting eccentric rotation to conduct adjustment and fixing.

4. The assembled A-shaped ladder according to claim 1, wherein the support frame assemblies comprise a first hole and a second hole formed therein at a location adjacent to the ancillary frames, the ancillary frames comprising a corresponding aperture formed therein, the corresponding aperture being selectively set to correspond to the first hole or the second hole to set the ancillary frames in a stowed condition or an expanded condition.

5. An assembled A-shaped ladder, comprising:
a top ladder segment;
a plurality of middle ladder segments, which are coupled to the top ladder segment through insertion; and
a plurality of bottom ladder segments, which are coupled to the middle ladder segments through coupling, the bottom ladder segments further comprising:
a ladder body, which comprises a receiving space formed therein;
a plurality of support frame assemblies, which has an end coupled to the ladder body, the support frame assemblies being respectively set at two sides of the ladder body;
a plurality of ancillary frames, which is movably mounted to an end of the support frame assemblies that is distant from the ladder body;
a plurality of adjustable support pads, which is screwed to an end of the ancillary frames that is distant from the support frame assemblies; and
a plurality of adjustable coupling members, which functions for adjusting and fixing the support frame assemblies and the ladder body, the adjustable coupling members having an end coupled to the support frame assemblies and an opposite end received in the receiving space.

6. The assembled A-shaped ladder according to claim 5, wherein the top ladder segment and the middle ladder segments each have a lower end that forms a plurality of support legs, the support legs being provided for insertion and fixing for coupling the top ladder segment, the middle ladder segments, and the bottom ladder segments together, the support legs comprising a fixing hole formed therein to receive a mounting bolt to insert therein for coupling purposes.

7. The assembled A-shaped ladder according to claim 5, wherein the ladder body further comprises a plurality of fixing members, which function to fix the adjustable coupling members, the fixing members having an end mounted to the ladder body and adopting eccentric rotation to conduct adjustment and fixing.

8. The assembled A-shaped ladder according to claim 5, wherein the support frame assemblies comprise a first hole and a second hole formed therein at a location adjacent to the ancillary frames, the ancillary frames comprising a corresponding aperture formed therein, the corresponding aperture being selectively set to correspond to the first hole or the second hole to set the ancillary frames in a stowed condition or an expanded condition.
